(19) United States
(12) Patent Application Publication
(10) Pub. No.: US 2026/0169495 A1
(43) Pub. Date: Jun. 18, 2026

(54) MOTION CONTROL METHOD, SWEEPING MACHINE, AND COMPUTER-READABLE STORAGE MEDIUM

(71) Applicants: Best Epoch Technology Co., LTD, Shenzhen (CN); UBTECH ROBOTICS CORP LTD, Shenzhen (CN)

(72) Inventors: GAOBO HUANG, Shenzhen (CN); Xiangbin Huang, Shenzhen (CN); Liuchen Yang, Shenzhen (CN); Junfeng Huang, Shenzhen (CN)

(21) Appl. No.: 19/531,676

(22) Filed: Feb. 6, 2026

Related U.S. Application Data
(63) Continuation of application No. PCT/CN2023/141895, filed on Dec. 26, 2023.

(30) Foreign Application Priority Data
Aug. 8, 2023 (CN) 202310993393.X

(51) Int. Cl. G05D 1/646; G05D 1/622; G05D 105/10; G05D 107/50

(52) U.S. Cl. CPC G05D 1/646; G05D 1/622; G05D 2105/10; G05D 2107/50

(57) ABSTRACT

A motion control method, a sweeping machine, and a computer-readable storage medium are provided. The method includes: controlling a second wheel to rotate around a first wheel so that second wheel moves in a direction for passing through a passage, in response to a sweeping machine locating at an entrance of the passage; controlling the sweeping machine to move backward in response to a distance between the sweeping machine and the obstacle being less than a predetermined first distance threshold; and controlling the sweeping machine to rotate at a first predetermined angle around a center so that first wheel moves in the direction for passing through the passage, in response to the distance between the sweeping machine and the obstacle being larger than or equal to the predetermined first distance threshold, and returning to the step of controlling the second wheel until the sweeping machine passes through the passage.

### CROSS REFERENCE TO RELATED APPLICATIONS

The present disclosure is a continuation-application of International Application PCT/CN2023/141895, with an international filing date of Dec. 26, 2023, which claims foreign priority of Chinese Patent Application No. 202310993393.X, filed on Aug. 8, 2023 in the State Intellectual Property Office of China, the contents of all of which are hereby incorporated by reference.

### TECHNICAL FIELD

The present disclosure relates to sweeping machine technology, and particularly to a motion control method, a sweeping machine, and a computer-readable storage medium.

### BACKGROUND

The basic ideas of sweeping machines to perform cleaning usually include dividing areas, along edge movement, and coverage cleaning, or the like. Through the ideas of dividing areas and along edge movement, the areas to be cleaned are enclosed into closed areas on the map to perform coverage cleaning. During the coverage cleaning, the along edge movement cleaning will be performed around the edge to enclose the obstacle on the map.

Through the along edge movement, it can better balance the efficiency of along edge movements and getting close to most obstacles for the movements. However, due to the often complex and diverse home environments, there are often narrow areas to be swept by the sweeping machines, such as under the dining table with many table and chair legs, and in a room with half-closed door. In these narrow passage scenes, it is sometimes difficult for the sweeping machine to enter through the conventional along edge movement approaches, which may cause missed sweeping, and is not conducive to improving the sweeping coverage of the sweeping machines.

### BRIEF DESCRIPTION OF DRAWINGS

FIG. 1 is a schematic diagram of the structure of a sweeping machine according to an embodiment of the present disclosure.

FIG. 2 is a flow chart of a motion control method according to the first embodiment of the present disclosure.

FIGS. 3-9 are schematic diagrams of the scenarios of controlling a sweeping machine to pass through a passage according to an embodiment of the present disclosure.

FIG. 10 is a flow chart of an example of retreating from a passage according to the motion control method in FIG. 2.

FIG. 11 is a schematic diagram of a scenario that retreating from passage is triggered according to an embodiment of the present disclosure.

FIG. 12 is a flow chart of another example of retreating from a passage according to the motion control method in FIG. 2.

FIGS. 13-21 are schematic diagrams of the scenarios of controlling a sweeping machine to retreat from a passage according to an embodiment of the present disclosure.

FIG. 22 is a schematic diagram of a motion control device for a sweeping machine according to an embodiment of the present disclosure.

FIG. 23 is a schematic diagram of a sweeping machine according to an embodiment of the present disclosure.

### DETAILED DESCRIPTION

In the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

For the purpose of describing the technical solutions of the present disclosure, the following describes through specific embodiments.

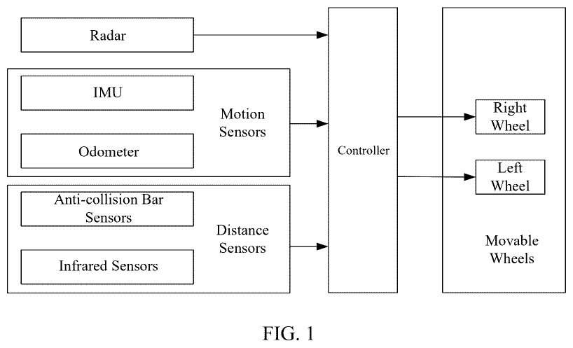

FIG. 1 is a schematic diagram of the structure of a sweeping machine according to an embodiment of the present disclosure. As shown in FIG. 1, the sweeping machine (i.e., sweeper) may include a radar, sensors, a controller and movable wheels. In which, the sensors may include ranging sensors, motion sensors, and the like. The ranging sensor may include infrared sensors and anti-collision bar sensors. The anti-collision bar sensor may include a left anti-collision bar sensor and a right anti-collision bar sensor that may be used to detect whether a collision will occur on the left, right or front of the sweeping machine. When a collision occurs on the left side, the left anti-collision bar sensor may be triggered; when a collision occurs on the right side, the right anti-collision bar sensor may be triggered; and when a collision occurs in the front, both the left anti-collision bar sensor and the right anti-collision bar sensor may be triggered.

The infrared sensors may be used to detect the distance between the sweeping machine and obstacles. More than two infrared sensors may be installed to detect the distance between each side of the sweeping machine and the obstacles. The anti-collision strip sensors may also be used to detect the distance between the sweeping machine and the obstacles. For example, when the left collision bar sensor is triggered, it may detect to ensure that the distance between the sweeping machine and the obstacle on the left is less than a preset first distance threshold. The first distance threshold may be the distance between the sweeping machine and the obstacle when the sweeping machine collides with the obstacle, or may be any value larger than this distance.

The motion sensor may include an IMU (Inertial Measurement Unit) and/or an odometer. The motion sensor may detect motion information of the sweeping machine, and the sweeping machine may update the scene map based on the detected motion information. The radar may be used to detect obstacle information in the scene, and the sweeping machine may generate the scene map based on the detected obstacle information that may be used to determine the passages existing in a scene.

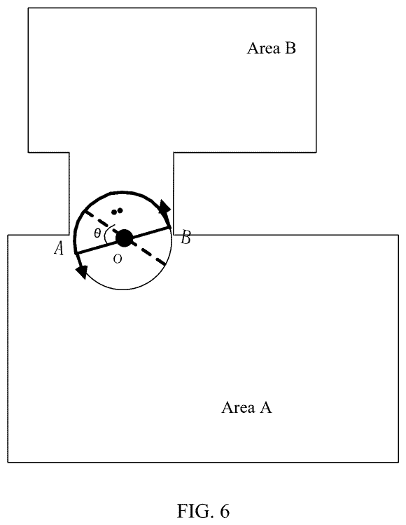

The movable wheels may include a left wheel and a right wheel. The controller may control the left wheel and the right wheel to move according to the detected passages. For example, it may control the left wheel to move around the right wheel, or the movement of the left wheel and the right wheel so that the sweeping machine moves around its center (e.g., center o in FIG. 6). The controller may be used to control the sweeping machine to pass through narrow passages according to a motion control method provided in the embodiments of the present disclosure to improve the sweeping coverage of the sweeping machine.

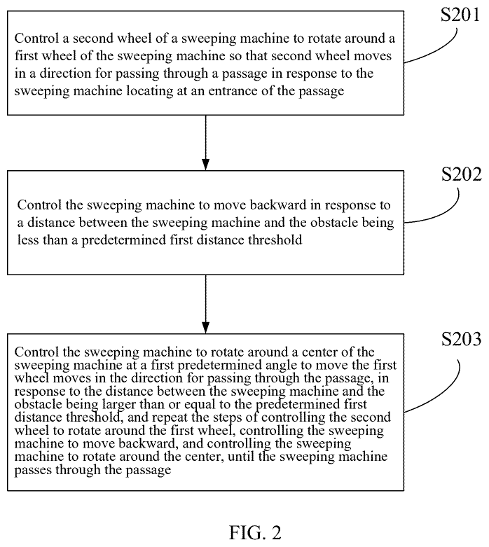

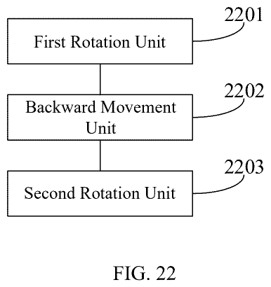

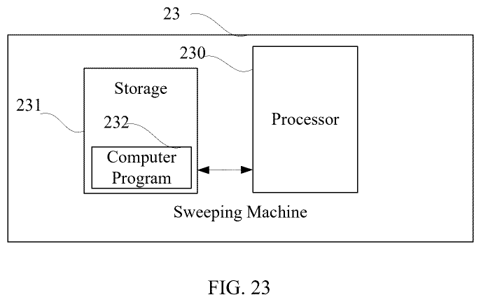

FIG. 2 is a schematic flow chart of the implementation of a motion control method for a sweeping machine provided by an embodiment of the present disclosure. In this embodiment, a motion control method for a sweeping machine is provided. The motion control method may be applied to (a processor of) the sweeping machine in FIG. 1. In other embodiments, the method may be applied to a motion control device as shown in FIG. 22 or a sweeping machine as shown in FIG. 23. As shown in FIG. 2, the motion control method may include the following steps.

S201: controlling the second wheel of the sweeping machine to rotate around the first wheel of the sweeping machine so that second wheel moves in a direction for passing through a passage in response to the sweeping machine locating at an entrance of the passage.

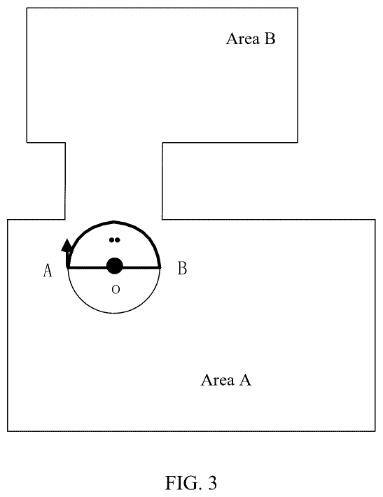

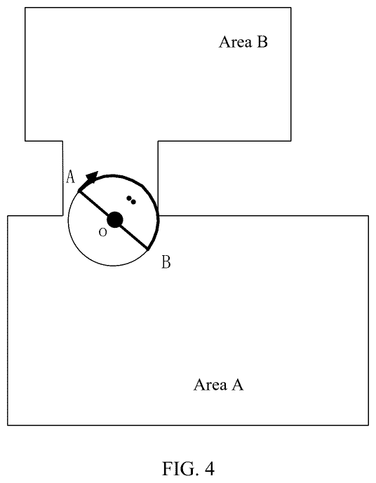

In this embodiment, a distance between the first wheel and an obstacle of the passage is less than a distance between the second wheel and the obstacle. In which, the passage may be a passageway, a gap, or the like that allows the sweeping machine to pass through; and the obstacle maybe a side wall, an edge, or the like that composes the passage itself, or an extra object such as a furniture, a person, or a garbage.

In which, the sweeping machine is outside the passage, which may be in the left side near to the entrance of the passage, or in the right side near to the entrance of the passage. For example, when the sweeping machine is going to be moved through the left side, it may be moved to the position on the left side near to the entrance of the passage; and when the sweeping machine is going to be moved through the right side, the sweeping machine may be moved to the position on the right side near to the entrance of the passage. FIGS. 3-9 are schematic diagrams of the scenarios of controlling the sweeping machine to pass through the passage according to an embodiment of the present disclosure. As shown in FIG. 3, for example, according to a pre-detected scene map, when the sweeping machine is moved from the right side to a position near to the passage (i.e., the passageway between Area A and Area B) (see FIG. 4), it is located at the right side of the entrance of the passage. It should be noted that the movement is not limited to moving from the right side to the right side of the entrance of the passage, but also include moving from other positions to the right side of the entrance of the passage. Similarly, the sweeping machine may also be moved from the left side or other sides to the left side of the entrance of the passage.

As shown in FIG. 3, in the case that the sweeping machine is located at the right side of the entrance of the passage, the distance between the right wheel B and its nearest obstacle of the passage (e.g., the right side wall of the passage) is less than that between the left wheel A and the obstacle. Therefore, the right wheel B is the first wheel and the left wheel A is the second wheel. When the left wheel A is rotated around the right wheel B, the sweeping machine can be rotated in a clockwise direction to make the left wheel A of the sweeping machine to move in the direction of passing through (i.e., entering) the passage, so that the left wheel A of the sweeping machine moves in the direction of entering the passage and the sweeping machine gets close to the right side wall of the passage.

Conversely, in the case that the sweeping machine is located at the left side of the entrance of the passage, the distance between the left wheel A and an obstacle (e.g., the left side wall of the passage) is less than that between the right wheel B and the obstacle. In this case, the left wheel A is the first wheel and the right wheel B is the second wheel. It may control the right wheel B to rotate counterclockwise to move in the direction of passing through (i.e., entering) the passage.

When the second wheel is rotated around the first wheel, the position of the first wheel remains unchanged, and the second wheel gradually moves toward the direction of entering the passage with the first wheel as the center. During the rotation of the second wheel, the distance between the sweeping machine and the obstacle on the side of the first wheel will gradually decrease.

It should be noted that when the first distance threshold is larger than a collision distance, the distance between the sweeping machine and the obstacle may be detected through a distance sensor like an infrared sensor.

S202: controlling the sweeping machine to move backward in response to a distance between the sweeping machine and the obstacle being less than a predetermined first distance threshold.

During controlling the second wheel to rotate around the first wheel in the direction of passing through the passage, as the rotation angle increases, the distance between the sweeping machine and the obstacle will gradually decrease. When it requires the distance between the sweeping machine and the obstacle to be less than the first distance threshold, the distance between the sweeping machine and the obstacle will be small, or the sweeping machine will collide with the obstacle. At this time, in order to allow the sweeping machine to move further forward, the sweeping machine may be controlled to move backward at a first predetermined distance, so that the sweeping machine can continue to move in the direction of passing through the passage through rotation.

If the distance is less than the predetermined first distance threshold, the control of the second wheel to rotate around the first wheel will be stopped.

As shown in FIG. 4, for example, if the first distance threshold is the distance at which a collision between the sweeping machine and the obstacle (at one side of the passage) will occur, the distance between the sweeping machine and the obstacle (hereinafter referred to as the collision distance) may be detected through the anti-collision bar sensor so as to determine whether it is necessary to stop the rotation of the second wheel around the first wheel. if the anti-collision bar sensor detects that the sweeping machine and the obstacle collides, the sweeping machine is controlled to stop rotating the second wheel around the first wheel. Due to the sweeping machine collides with the obstacle on one side of the passage and cannot be moved in the direction of passing the passage by further rotating around the first wheel, it stops controlling the second wheel to rotate around the first wheel and controls the sweeping machine to move backward so as to eliminate the collision between the sweeping machine and the obstacle.

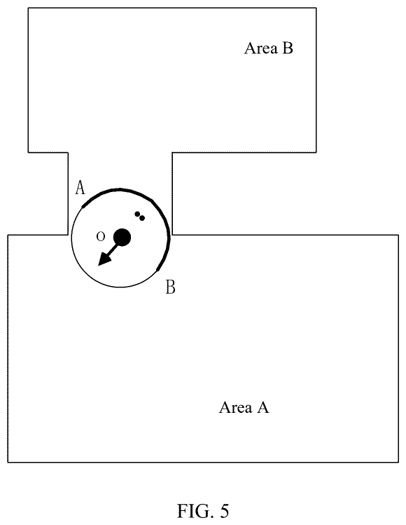

If the first distance threshold is larger than the collision distance, the distance between the sweeping machine and the obstacle may be detected through the distance sensor. If it is detected that the distance between the sweeping machine and the obstacle is less than the first distance threshold, it may stop the control of the second wheel to rotate around the first wheel, and then control the sweeping machine to move backward so that the distance between the sweeping machine and the obstacle gradually increases. As shown in FIG. 5, after moving backward, the distance between the sweeping machine and the obstacle is larger than the collision distance, and the collision between the sweeping machine and the obstacle is eliminated.

S203: controlling the sweeping machine to rotate around a center of the sweeping machine at a first predetermined angle to move the first wheel moves in the direction for passing through the passage, in response to the distance between the sweeping machine and the obstacle being larger than or equal to the predetermined first distance threshold, and repeating the steps of controlling the second wheel to rotate around the first wheel, controlling the sweeping machine to move backward, and controlling the sweeping machine to rotate around the center, until the sweeping machine passes through the passage.

During controlling the sweeping machine to move backward, the distance between the sweeping machine and the obstacle is detected in real time. If the distance between the sweeping machine and the obstacle is larger than or equal to the first distance threshold, the direction of the sweeping machine may be adjusted so that the first wheel of the sweeping machine is moved to the front of the passage by rotation, thereby further facilitating the rotation of the second wheel around the first wheel, and then allowing the sweeping machine to move in the direction of passing through the passage by rotation.

If the first distance threshold is the collision distance, the sweeping machine may be controlled to move backward so that the distance between the sweeping machine and the obstacle is larger than the collision distance, and then the sweeping machine may be controlled to rotate around its center so that the first wheel of the sweeping machine moves in the direction of passing through the passage.

In order to effectively control the sweeping machine to pass through the passage, the distance of moving the sweeping machine backward in the direction of the passage is less than that of moving the sweeping machine in the direction of the passage when the second wheel is rotated around the first wheel.

When controlling the sweeping machine to rotate around its center, since the distance between the sweeping machine and the obstacle is larger than or equal to the first distance threshold, the sweeping machine will not collide with the obstacle on one side of the passage, and the rotation of the sweeping machine at the first predetermined angle around the center can be effectively completed.

Since the sweeping machine will not collide with the obstacle on one side of the passage when it is rotated around the center, the direction of rotating the sweeping machine around its center at the first predetermined angle does not need to be limited. In order to improve the rotation efficiency, the rotation direction of the first predetermined angle may be determined according to the position of the sweeping machine entering the passage.

For example, when the sweeping machine enters the passage from the right side of the passage, the second wheel is rotated around the first wheel in a clockwise direction. As shown in FIG. 6, after the sweeping machine is moved backward, it is controlled to rotate counterclockwise around the center of the sweeping machine at the first predetermined angle θ (e.g., 30 degrees). In which the center is the geometry center of the sweeping machine, for example, the circle center.

If the sweeping machine enters the passage from the left side of the passage, the second wheel is rotated around the first wheel in a counterclockwise direction. After the sweeping machine is moved backward, it is controlled to rotate clockwise at the first predetermined angle around the center.

After the second wheel is rotated around the first wheel, the second wheel is located behind the first wheel (i.e., the opposite direction of the passage). By rotating around the center of the sweeping machine, the first wheel is moved toward the front of the passage.

As shown in FIG. 6, when the sweeping machine is rotated counterclockwise around center o, the distance between the first wheel and the nearest obstacle will gradually decrease as the first wheel gradually moves forward. When the first wheel is located on a line between the center of the sweeping machine and the nearest obstacle, the distance between the first wheel and the nearest obstacle has the minimum value. By continuing to control the sweeping machine to rotate around center o, the distance between the first wheel and the nearest obstacle will gradually increase. The larger the distance between the first wheel and the nearest obstacle, the larger the space of the passage is required when the second wheel rotates around the first wheel and the larger the movement distance in a single rotation (i.e., the second wheel rotates around the first wheel), then the higher the passing efficiency of the sweeping machine. Therefore, the size of the first predetermined angle may be determined according to the width of the passage and the passing speed of the sweeping machine. In the case that the passing speed is a constant value, the larger the width of the passage, and the larger the first predetermined angle; otherwise, the smaller the width of the passage, the smaller the first predetermined angle. In the case that the width is constant, the faster the passing speed, the larger the first predetermined angle; otherwise, the slower the passing speed, the smaller the first predetermined angle. The size of the first predetermined angle may be determined based on the preset passing speed and the width of the passage.

After the sweeping machine is rotated at the first predetermined angle, if the sweeping machine is still in the passage, it may control the second wheel of the sweeping machine to rotate around the first wheel according to the control process shown in FIGS. 3-6 again, so that the sweeping machine moves forward. If the distance between the sweeping machine and the obstacle is less than the first distance threshold, or if the sweeping machine collides with the obstacle, the sweeping machine is controlled to move backward; otherwise, if the distance between the sweeping machine and the obstacle is larger than or equal to the first distance threshold, for example, the sweeping machine does not collide with the obstacle, the sweeping machine is rotated at the first predetermined angle. In this manner, the steps of rotating the second wheel around the first wheel, moving backward, and rotating around the center are repeatedly performed until the sweeping machine is moved out of the passage. Then, the sweeping machine may continue to be controlled according to another control method outside the passage so as to perform a predetermined task.

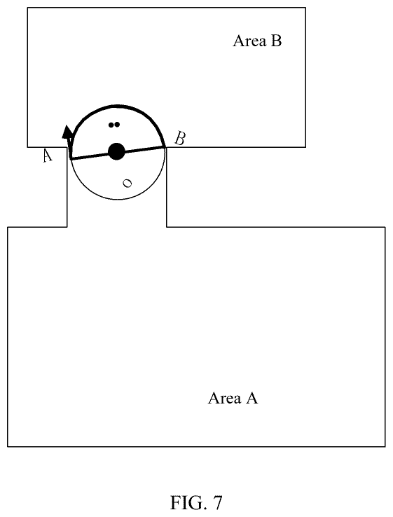

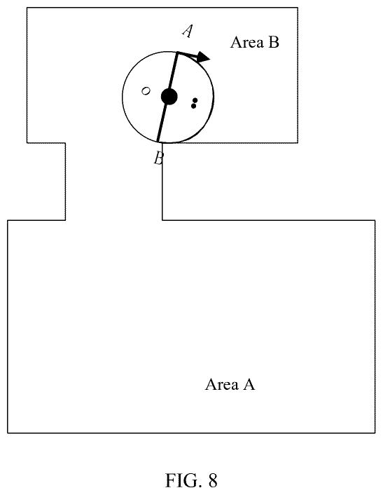

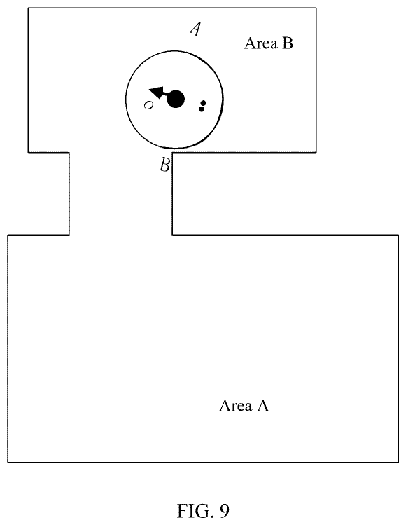

As shown in FIG. 7, for example, by rotating around the center, the first wheel of the sweeping machine is located at the right side of the exit of the passage. At this time, the second wheel of the sweeping machine is still in the passage. The first wheel of the sweeping machine may be controlled to rotate around the second wheel until, as shown in FIG. 8, the sweeping machine collides with the obstacle. In order to eliminate the collision, as shown in FIG. 9, the sweeping machine may be controlled to move backward to eliminate the collision between the sweeping machine and the obstacle. At this time, the sweeping machine is completely outside the passage and has successfully entered area B from area A through the passage. Then, the sweeping machine may be controlled according to the control method of a predetermined non-passage scene so as to perform the predetermined task.

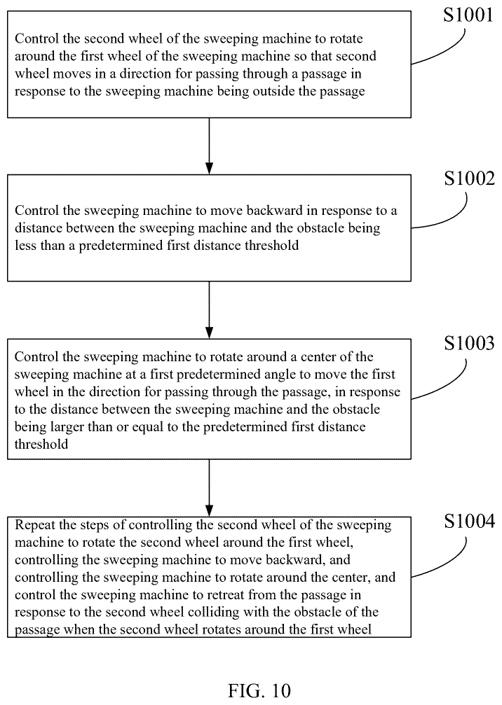

In a possible application scenario, the width of the passage can change. If the width of the passage becomes smaller when the sweeping machine enters the passage, the sweeping machine could not be able to continue moving forward, and therefore needs to be controlled to retreat from the passage. FIG. 10 is a flow chart of an example of retreating from a passage according to the motion control method in FIG. 2. As shown in FIG. 10, the motion control method may include the following steps.

S1001: controlling the second wheel of the sweeping machine to rotate around the first wheel of the sweeping machine so that second wheel moves in a direction for passing through a passage in response to the sweeping machine being outside the passage.

S1002: controlling the sweeping machine to move backward in response to a distance between the sweeping machine and the obstacle being less than a predetermined first distance threshold.

S1003: controlling the sweeping machine to rotate around a center of the sweeping machine at a first predetermined angle to move the first wheel in the direction for passing through the passage, in response to the distance between the sweeping machine and the obstacle being larger than or equal to the predetermined first distance threshold.

S1001-S1003 are identical to S201-S203 in FIG. 2.

S1004: repeating the steps of controlling the second wheel of the sweeping machine to rotate the second wheel around the first wheel, controlling the sweeping machine to move backward, and controlling the sweeping machine to rotate around the center, and controlling the sweeping machine to retreat from the passage in response to the second wheel colliding with the obstacle of the passage when the second wheel rotates around the first wheel.

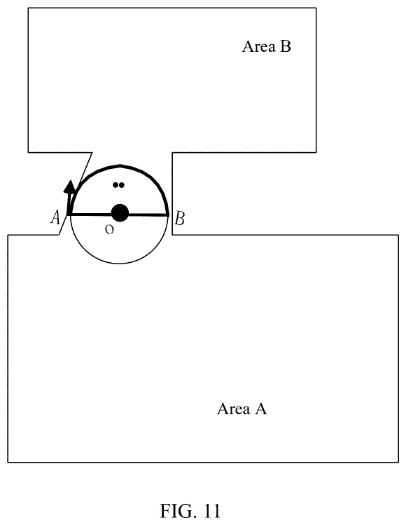

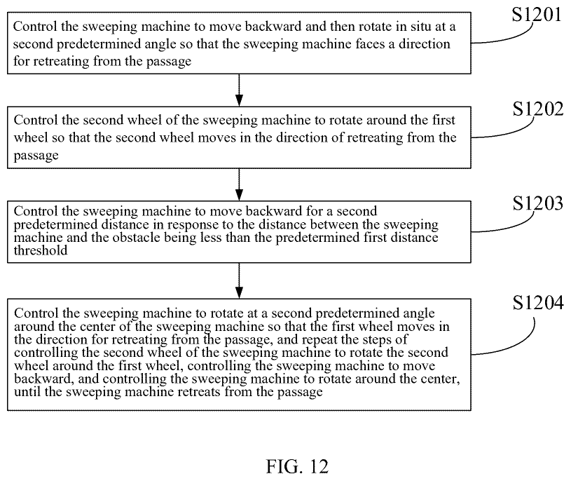

FIG. 11 is a schematic diagram of a scenario that retreating from passage is triggered according to an embodiment of the present disclosure. As shown in FIG. 11, if the shape of the passage is large at the front and small at the back, at the front end of the passage, the sweeping machine can enter the passage according to the method as shown in FIG. 2. As the passage shrinks, if the second wheel of the sweeping machine collides with (the side wall of) the passage when the sweeping machine rotates the second wheel around the first wheel for the N-th (N is a natural number larger than or equal to 1) time, which means that the width of the passage is too small to allow the sweeping machine to pass through. FIG. 12 is a flow chart of another example of retreating from a passage according to the motion control method in FIG. 2. As shown in FIG. 12, the motion control method may include the following steps.

S1201: controlling the sweeping machine to move backward and then rotate in situ at a second predetermined angle so that the sweeping machine faces a direction for retreating from the passage.

If the second wheel of the sweeping machine is rotated around the first wheel and it is detected that the second wheel has collided with the obstacle, it means that the width of the passage is less than the width of the sweeping machine. If the sweeping machine cannot pass through the passage, it may first adjust the distance between the sweeping machine and the obstacle by moving backward, and then adjust the direction of the sweeping machine so that the sweeping machine moves in the direction of retreating from the passage.

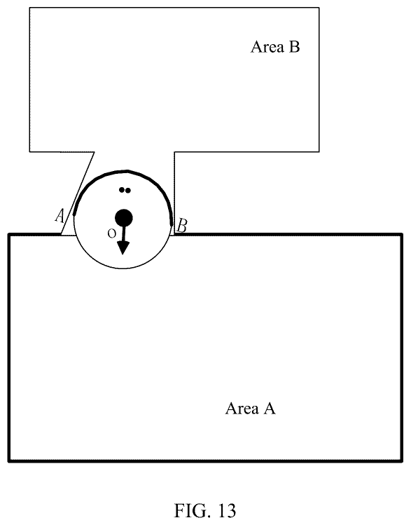

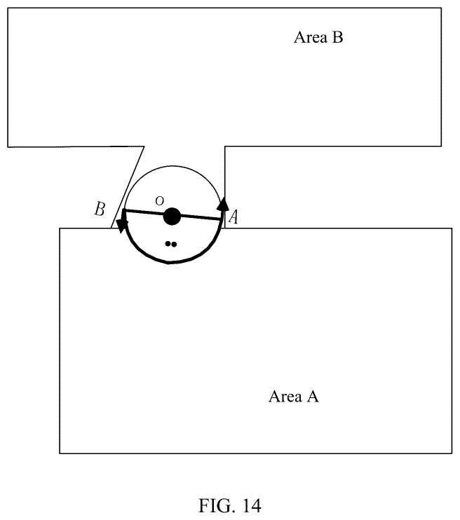

FIGS. 13-21 are schematic diagrams of the scenarios of controlling a sweeping machine to retreat from a passage according to an embodiment of the present disclosure. During the rotation of the second wheel around the first wheel, if the distance between the second wheel and the obstacle is less than the first distance threshold, for example, the second wheel collides with the obstacle (see FIG. 11), as shown in FIG. 13, it may stop rotating the second wheel around the first wheel and control the sweeping machine to move backward so as to eliminate the collision between the second wheel and the obstacle. That is, if the distance between the sweeping machine and the obstacle is larger than or equal to the first distance threshold, it may control the sweeping machine to rotate in situ (i.e., rotate around the center) so that the sweeping machine faces the direction of retreating from the passage. For example, the sweeping machine may be controlled to rotate 180 degrees in situ to change the positions of the first wheel and second wheel of the sweeping machine. Before rotating 180 degrees, as shown in FIG. 11, the first wheel is on the right and the second wheel is on the left; and after rotating 180 degrees, as shown in FIG. 14, the first wheel is on the left and the second wheel is on the right.

S1202: controlling the second wheel of the sweeping machine to rotate around the first wheel so that the second wheel moves in the direction of retreating from the passage.

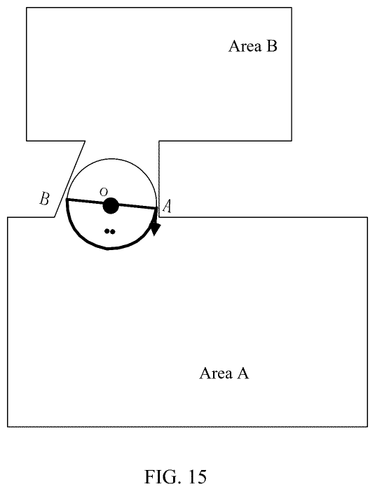

As shown in FIG. 15, after changing the orientation of the sweeping machine, it may control the second wheel of the sweeping machine to rotate around the first wheel, so that the sweeping machine is moved in the direction of retreating from the passage and gets close to the obstacle on the left side wall of the passage.

S1203: controlling the sweeping machine to move backward for a second predetermined distance in response to the distance between the sweeping machine and the obstacle being less than the predetermined first distance threshold.

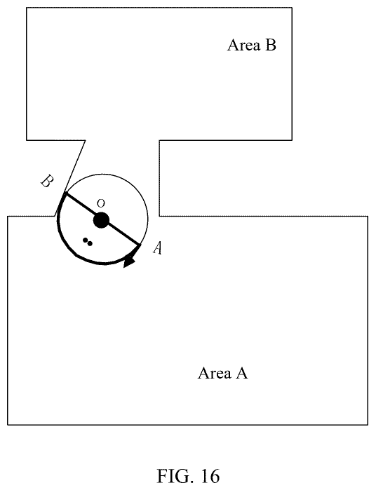

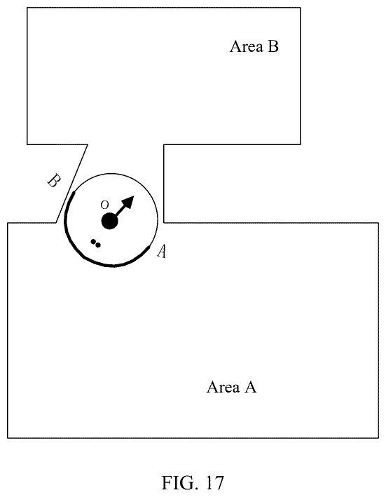

If the second wheel of the sweeping machine is rotated around the first wheel until the distance between the sweeping machine and the obstacle is less than the first distance threshold, for example, the sweeping machine collides with the obstacle on the left side of the passage (see FIG. 16), it may control the sweeping machine to move backward (i.e., move in the vertical direction of the connection between the first wheel and the second wheel that faces the direction of retreating from the passage), so that, as shown in FIG. 17, the distance between the sweeping machine and the obstacle is larger than or equal to the first distance threshold so as to eliminate the collision between the obstacle and the sweeping machine.

S1204: controlling the sweeping machine to rotate at a second predetermined angle around the center of the sweeping machine so that the first wheel moves in the direction for retreating from the passage, and repeating the steps of controlling the second wheel of the sweeping machine to rotate the second wheel around the first wheel, controlling the sweeping machine to move backward, and controlling the sweeping machine to rotate around the center, until the sweeping machine retreats from the passage. The second predetermined angle is slightly less than the first predetermined angle.

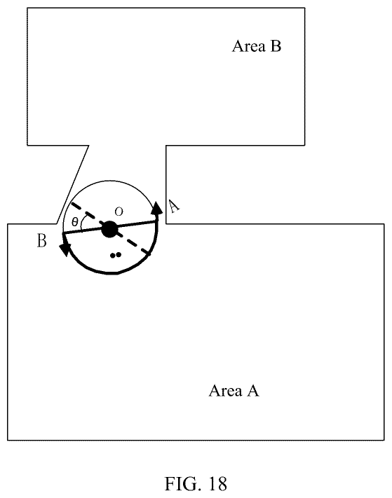

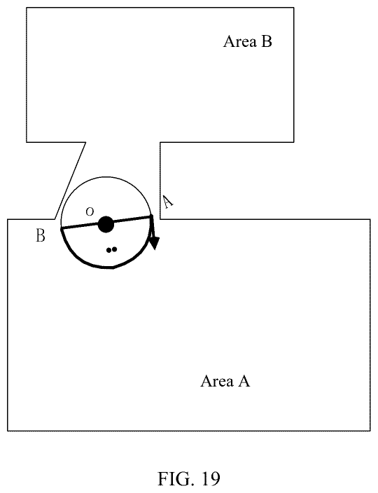

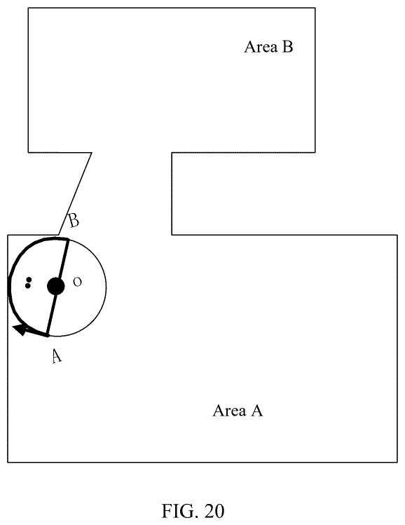

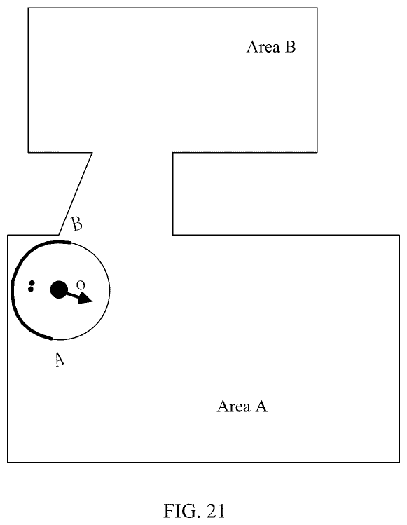

If the distance between the sweeping machine and the obstacle is larger than the first distance threshold, for example, after the collision is eliminated, the sweeping machine may be controlled to rotate in situ at a second predetermined angle so that, as shown in FIG. 18, the first wheel of the sweeping machine moves toward the outside of the passage, which facilitates the second wheel to further move in the direction of retreating from the passage when the second wheel is rotated around the first wheel. By repeatedly rotating the second wheel around the first wheel, moving backward, and rotating around the center, until the sweeping machine retreats from the passage, as shown in FIG. 19, for example, the first wheel is located on the left side of the entrance of the passage, then the second wheel is controlled to rotate around the first wheel to obtain the state shown in FIG. 20 that the sweeping machine collides with the obstacle in area A. Then, the sweeping machine may be controlled to move backward to eliminate the collision and obtain the state of the sweeping machine as shown in FIG. 21. At this time, the sweeping machine has completely retreated from the passage.

In which, the selection of the second predetermined angle is similar to that of the first predetermined angle. That is, the size of the second predetermined angle may be determined according to the width of the passage and the required passing speed.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 22 is a schematic diagram of a motion control device (e.g., the above-mentioned controller) for a sweeping machine according to an embodiment of the present disclosure. As shown in FIG. 22, the motion control device may include:
a first rotation unit 2201 configured to control the second wheel of the sweeping machine to rotate around the first wheel of the sweeping machine so that second wheel moves in a direction for passing through a passage in response to the sweeping machine being outside the passage, wherein a distance between the first wheel and an obstacle of the passage is less than a distance between the second wheel and the obstacle;
a backward movement unit 2202 configured to control the sweeping machine to move backward in response to a distance between the sweeping machine and the obstacle being less than a predetermined first distance threshold; and
a second rotation unit 2203 configured to control the sweeping machine to rotate around a center of the sweeping machine at a first predetermined angle to move the first wheel in the direction for passing through the passage, in response to the distance between the sweeping machine and the obstacle being larger than or equal to the predetermined first distance threshold, and returning to control the second wheel of the sweeping machine to rotate the second wheel around the first wheel, control the sweeping machine to move backward, and control the sweeping machine to rotate around the center, until the sweeping machine retreats from the passage.

The motion control device of the sweeping machine shown in FIG. 22 corresponds to the motion control method of the sweeping machine shown in FIG. 2.

FIG. 23 is a schematic diagram of a sweeping machine according to an embodiment of the present disclosure. As shown in FIG. 23, in this embodiment, the sweeping machine 23 includes a processor 230, a storage 231, and a computer program 232 stored in the storage 231 and executable on the processor 230, for example, a motion control program for sweeping machine. When executing (instructions in) the computer program 232, the processor 230 implements the steps in the above-mentioned embodiments of the motion control method. Alternatively, when the processor 230 executes the (instructions in) computer program 232, the functions of each module / unit in the above-mentioned device embodiments.

Exemplarily, the computer program 232 may be divided into one or more modules/units, and the one or more modules/units are stored in the storage 231 and executed by the processor 230 to realize the present disclosure. The one or more modules/units may be a series of computer program instruction sections capable of performing a specific function, and the instruction sections are for describing the execution process of the computer program 232 in the sweeping machine 23.

The sweeping machine 23 may include, but is not limited to, the processor 230 and the storage 231. It should be noted by those skilled in the art that FIG. 23 is merely an example of the sweeping machine 23 and does not constitute a limitation on the sweeping machine 23, and may include more or fewer components than those shown in the figure, or a combination of some components or different components. For example, the sweeping machine 23 may further include an input/output device, a network access device, a bus, and the like.

The processor 230 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

The storage 231 may be an internal storage unit of the sweeping machine 23, for example, a hard disk or a memory of the sweeping machine 23. The storage 231 may also be an external storage device of the sweeping machine 23, for example, a plug-in hard disk, a smart media card (SMC), a secure digital (SD) card, flash card, and the like, which is equipped on the sweeping machine 23. Furthermore, the storage 231 may further include both an internal storage unit and an external storage device, of the sweeping machine 23. The storage 231 is configured to store the computer program 232 and other programs and data required by the sweeping machine 23. The storage 231 may also be used to temporarily store data that has been or will be output.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/sweeping machine and method may be implemented in other manners. For example, the above-mentioned apparatus/sweeping machine embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

In addition, each functional unit in each of the embodiments of the present disclosure may be integrated into one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure are implemented, and may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any entity or device capable of carrying the computer program codes, a recording medium, a USB flash drive, a portable hard disk, a magnetic disk, an optical disk, a computer memory, a read-only memory (ROM), a random access memory (RAM), electric carrier signals, telecommunication signals and software distribution media. It should be noted that the content contained in the computer-readable medium may be appropriately increased or decreased according to the requirements of legislation and patent practice in the jurisdiction. For example, in some jurisdictions, according to the legislation and patent practice, a computer-readable medium does not include electric carrier signals and telecommunication signals.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A motion control method for a sweeping machine having a first wheel and a second wheel, comprising:
controlling the second wheel to rotate around the first wheel so that second wheel moves in a direction for passing through a passage, in response to the sweeping machine locating at an entrance of the passage, wherein a distance between the first wheel and an obstacle of the passage is less than a distance between the second wheel and the obstacle;
controlling the sweeping machine to move backward in response to a distance between the sweeping machine and the obstacle being less than a predetermined first distance threshold; and
controlling the sweeping machine to rotate around a center of the sweeping machine at a first predetermined angle to move the first wheel in the direction for passing through the passage, in response to the distance between the sweeping machine and the obstacle being larger than or equal to the predetermined first distance threshold, and repeating the steps of controlling the second wheel to rotate around the first wheel, controlling the sweeping machine to move backward, and controlling the sweeping machine to rotate around the center, until the sweeping machine passes through the passage.

2. The method of claim 1, further comprising:
controlling the sweeping machine to retreat from the passage in response to one side of the sweeping machine near the second wheel colliding with another obstacle of the passage while the second wheel rotates around the first wheel.

3. The method of claim 2, wherein controlling the sweeping machine to retreat from the passage comprises:
controlling the sweeping machine to move backward and then rotate in situ a second predetermined angle so that the sweeping machine faces a direction for retreating from the passage;
controlling the second wheel to rotate around the first wheel so that the second wheel moves in the direction for retreating from the passage;
controlling the sweeping machine to move backward a second predetermined distance in response to the distance between the sweeping machine and the obstacle being less than the predetermined first distance threshold; and
controlling the sweeping machine to rotate the second predetermined angle around the center of the sweeping machine so that the first wheel moves in the direction for retreating from the passage, and repeating the steps of controlling the second wheel to rotate around the first wheel, controlling the sweeping machine to move backward, and control the sweeping machine to rotate around the center, until the sweeping machine retreats from the passage.

4. The method of claim 1, wherein the first distance threshold is a distance at which the sweeping machine collides with the obstacle.

5. The method of claim 1, wherein when the sweeping machine is on a left side of the passage, the first wheel is a left wheel and the second wheel is a right wheel; and
controlling the second wheel to rotate around the first wheel so that second wheel moves in the direction for passing through the passage comprises:
controlling the right wheel of the sweeping machine to rotate in a counterclockwise direction around the left wheel of the sweeping machine so that the second wheel moves in the direction of passing through the passage;
controlling the sweeping machine to rotate around the center of the sweeping machine at the first predetermined angle so that first wheel moves in the direction for passing through the passage, in response to the distance between the sweeping machine and the obstacle being larger than or equal to the predetermined first distance threshold comprises:
controlling the sweeping machine to rotate at the first predetermined angle in a clockwise direction around the center of the sweeping machine so that the first wheel moves in the direction of passing through the passage.

6. The method of claim 1, wherein when the sweeping machine is on a right side of the passage, the first wheel is a right wheel and the second wheel is a left wheel; and controlling the second wheel to rotate around the first wheel so that second wheel moves in the direction for passing through the passage comprises:
controlling the left wheel of the sweeping machine to rotate in a clockwise direction around the right wheel of the sweeping machine so that the second wheel moves in the direction of passing through the passage;
controlling the sweeping machine to rotate around the center of the sweeping machine at the first predetermined angle so that first wheel moves in the direction for passing through the passage, in response to the distance between the sweeping machine and the obstacle being larger than or equal to the predetermined first distance threshold comprises:
controlling the sweeping machine to rotate at the first predetermined angle in a counterclockwise direction around the center of the sweeping machine so that the first wheel moves in the direction of passing through the passage.

7. The method of claim 1, wherein the first predetermined angle is related to a width and a predetermined passing speed of the passage.

8. A sweeping machine, comprising:
a first wheel and a second wheel;
a processor;
a memory coupled to the processor; and
one or more computer programs stored in the memory and executable on the processor;
wherein, the one or more computer programs comprise:
instructions for controlling the second wheel to rotate around the first wheel so that second wheel moves in a direction for passing through a passage, in response to the sweeping machine locating at an entrance of the passage, wherein a distance between the first wheel and an obstacle of the passage is less than a distance between the second wheel and the obstacle;
instructions for controlling the sweeping machine to move backward in response to a distance between the sweeping machine and the obstacle being less than a predetermined first distance threshold; and
instructions for controlling the sweeping machine to rotate around a center of the sweeping machine at a first predetermined angle to move the first wheel in the direction for passing through the passage, in response to the distance between the sweeping machine and the obstacle being larger than or equal to the predetermined first distance threshold, and repeating the steps of controlling the second wheel to rotate around the first wheel, controlling the sweeping machine to move backward, and controlling the sweeping machine to rotate around the center, until the sweeping machine passes through the passage.

9. The sweeping machine of claim 8, wherein the one or more computer programs further comprise:
instructions for controlling the sweeping machine to retreat from the passage in response to one side of the sweeping machine near the second wheel colliding with another obstacle of the passage while the second wheel rotates around the first wheel.

10. The sweeping machine of claim 9, wherein the instructions for controlling the sweeping machine to retreat from the passage comprise:
instructions for controlling the sweeping machine to move backward and then rotate in situ a second predetermined angle so that the sweeping machine faces a direction for retreating from the passage;
instructions for controlling the second wheel to rotate around the first wheel so that the second wheel moves in the direction for retreating from the passage;
instructions for controlling the sweeping machine to move backward for a second predetermined distance in response to the distance between the sweeping machine and the obstacle being less than the predetermined first distance threshold; and
instructions for controlling the sweeping machine to rotate the second predetermined angle around the center of the sweeping machine so that the first wheel moves in the direction for retreating from the passage, and repeating the steps of controlling the second wheel to rotate around the first wheel, controlling the sweeping machine to move backward, and control the sweeping machine to rotate around the center, until the sweeping machine retreats from the passage.

11. The sweeping machine of claim 8, wherein the first distance threshold is a distance at which the sweeping machine collides with the obstacle.

12. The sweeping machine of claim 8, wherein when the sweeping machine is on a left side of the passage, the first wheel is a left wheel and the second wheel is a right wheel; and the instructions for controlling the second wheel to rotate around the first wheel so that second wheel moves in the direction for passing through the passage comprise:
instructions for controlling the right wheel of the sweeping machine to rotate in a counterclockwise direction around the left wheel of the sweeping machine so that the second wheel moves in the direction of passing through the passage;
instructions for controlling the sweeping machine to rotate around the center of the sweeping machine at the first predetermined angle so that first wheel moves in the direction for passing through the passage, in response to the distance between the sweeping machine and the obstacle being larger than or equal to the predetermined first distance threshold comprises:
instructions for controlling the sweeping machine to rotate at the first predetermined angle in a clockwise direction around the center of the sweeping machine so that the first wheel moves in the direction of passing through the passage.

13. The sweeping machine of claim 8, wherein when the sweeping machine is on a right side of the passage, the first wheel is a right wheel and the second wheel is a left wheel; and the instructions for controlling the second wheel to rotate around the first wheel so that second wheel moves in the direction for passing through the passage comprise:
instructions for controlling the left wheel of the sweeping machine to rotate in a clockwise direction around the right wheel of the sweeping machine so that the second wheel moves in the direction of passing through the passage;
instructions for controlling the sweeping machine to rotate around the center of the sweeping machine at the first predetermined angle so that first wheel moves in the direction for passing through the passage, in response to the distance between the sweeping machine and the obstacle being larger than or equal to the predetermined first distance threshold comprises:
instructions for controlling the sweeping machine to rotate at the first predetermined angle in a counterclockwise direction around the center of the sweeping machine so that the first wheel moves in the direction of passing through the passage.

14. The sweeping machine of claim 8, wherein the first predetermined angle is related to a width and a predetermined passing speed of the passage.

15. A non-transitory computer-readable storage medium for storing one or more computer programs, wherein the one or more computer programs comprise:
instructions for controlling a second wheel of a sweeping machine to rotate around a first wheel of the sweeping machine so that second wheel moves in a direction for passing through a passage, in response to the sweeping machine locating at an entrance of the passage, wherein a distance between the first wheel and an obstacle of the passage is less than a distance between the second wheel and the obstacle;
instructions for controlling the sweeping machine to move backward in response to a distance between the sweeping machine and the obstacle being less than a predetermined first distance threshold; and
instructions for controlling the sweeping machine to rotate around a center of the sweeping machine at a first predetermined angle to move the first wheel in the direction for passing through the passage, in response to the distance between the sweeping machine and the obstacle being larger than or equal to the predetermined first distance threshold, and repeating the steps of controlling the second wheel to rotate around the first wheel, controlling the sweeping machine to move backward, and controlling the sweeping machine to rotate around the center, until the sweeping machine passes through the passage.

16. The storage medium of claim 15, wherein the one or more computer programs further comprise:
instructions for controlling the sweeping machine to retreat from the passage in response to one side of the sweeping machine near the second wheel colliding with another obstacle of the passage while the second wheel rotates around the first wheel.

17. The storage medium of claim 16, wherein the instructions for controlling the sweeping machine to retreat from the passage comprise:
instructions for controlling the sweeping machine to move backward and then rotate in situ a second predetermined angle so that the sweeping machine faces a direction for retreating from the passage;
instructions for controlling the second wheel to rotate around the first wheel so that the second wheel moves in the direction for retreating from the passage;
instructions for controlling the sweeping machine to move backward for a second predetermined distance in response to the distance between the sweeping machine and the obstacle being less than the predetermined first distance threshold; and
instructions for controlling the sweeping machine to rotate the second predetermined angle around the center of the sweeping machine so that the first wheel moves in the direction for retreating from the passage, and repeating the steps of controlling the second wheel to rotate around the first wheel, controlling the sweeping machine to move backward, and control the sweeping machine to rotate around the center, until the sweeping machine retreats from the passage.

18. The storage medium of claim 15, wherein the first distance threshold is a distance at which the sweeping machine collides with the obstacle.

19. The storage medium of claim 15, wherein when the sweeping machine is on a left side of the passage, the first wheel is a left wheel and the second wheel is a right wheel; and the instructions for controlling the second wheel of the sweeping machine to rotate around the first wheel of the sweeping machine so that second wheel moves in the direction for passing through the passage comprise:
instructions for controlling the right wheel of the sweeping machine to rotate in a counterclockwise direction around the left wheel of the sweeping machine so that the second wheel moves in the direction of passing through the passage;
instructions for controlling the sweeping machine to rotate around the center of the sweeping machine at the first predetermined angle so that first wheel moves in the direction for passing through the passage, in response to the distance between the sweeping machine and the obstacle being larger than or equal to the predetermined first distance threshold comprises:
instructions for controlling the sweeping machine to rotate at the first predetermined angle in a clockwise direction around the center of the sweeping machine so that the first wheel moves in the direction of passing through the passage.

20. The storage medium of claim 15, wherein when the sweeping machine is on a right side of the passage, the first wheel is a right wheel and the second wheel is a left wheel; and the instructions for controlling the second wheel of the sweeping machine to rotate around the first wheel of the sweeping machine so that second wheel moves in the direction for passing through the passage comprise:
instructions for controlling the left wheel of the sweeping machine to rotate in a clockwise direction around the right wheel of the sweeping machine so that the second wheel moves in the direction of passing through the passage;
instructions for controlling the sweeping machine to rotate around the center of the sweeping machine at the first predetermined angle so that first wheel moves in the direction for passing through the passage, in response to the distance between the sweeping machine and the obstacle being larger than or equal to the predetermined first distance threshold comprises:
instructions for controlling the sweeping machine to rotate at the first predetermined angle in a counterclockwise direction around the center of the sweeping machine so that the first wheel moves in the direction of passing through the passage.
